(19) United States
(12) Patent Application Publication
(10) Pub. No.: US 2007/0182871 A1
(43) Pub. Date: Aug. 9, 2007

(54) LIQUID CRYSTAL DISPLAY PANEL, LIQUID CRYSTAL DISPLAY DEVICE, AND METHOD THEREOF

(75) Inventors: Young Nam YUN, Gunpo-si (KR); Ji Hye MOON, Seoul (KR); Myung Hi LEE, Suwon-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/537,707

(22) Filed: Oct. 2, 2006

(30) Foreign Application Priority Data
Feb. 7, 2006 (KR) 1020060011518

(51) Int. Cl. G02F 1/1343

(52) U.S. Cl. 349/38

(57) ABSTRACT

A liquid crystal display (“LCD”) panel, an LCD device, and a method thereof are capable of preventing a brightness phenomenon of the outermost liquid crystal cells. The LCD panel includes thin film transistors (“TFTs”) connected to gate lines and to data lines, liquid crystal cells including pixel electrodes connected to the TFTs, and auxiliary capacitors connected to the liquid crystal cells. The auxiliary capacitors connected to the liquid crystal cells corresponding to first and last signal lines of at least one of the gate lines and the data lines have different capacitances from the auxiliary capacitors connected to the liquid crystal cells corresponding to remaining signal lines.

This application claims priority to Korean Patent Application No. 2006-0011518, filed on Feb. 7, 2006 and all the benefits accruing therefrom under 35 U.S.C. §119, and the contents of which in its entirety are herein incorporated by reference.

### BACKGROUND OF THE INVENTION

1. Field of the Invention

The present invention relates to a liquid crystal display (“LCD”) panel, an LCD device, and method thereof, and more particularly, to an LCD panel, an LCD device, and a method thereof improving luminance uniformity of the LCD panel.

2. Description of the Related Art

An LCD device displays an image by using the electro-optical characteristics of liquid crystal and includes an LCD panel for display an image through a liquid crystal cell matrix and driving circuits for driving the LCD panel.

The LCD panel includes, as shown in FIG. 1, gate lines GL, data lines DL crossing the gate lines GL, thin film transistors (“TFTs”) formed in regions defined by intersections of the gate lines GL and the data lines DL, and pixel electrodes PXL connected to the TFTs. The first data line DL1 forms a first parasitic capacitor Ca1 together with the pixel electrode PXL on a right side thereof. On the other hand, each of the second to m^{th} data lines DL2 to DLm forms first and second parasitic capacitors Ca1 and Ca2 together with the pixel electrodes PXL on both right and left sides thereof respectively. Hence, a variation of a pixel voltage signal charged to the pixel electrode PXL connected to the first data line DL1 due to the first parasitic capacitor Ca1 is different from that charged to each of the pixel electrodes PXL connected to the second to m^{th} data lines DL2 to DLm due to a coupling phenomenon of the first and second capacitors Ca1 and Ca2. Thus, a luminance difference occurs between a liquid crystal cell including the pixel electrode PXL connected to the first data line DL1 and liquid crystal cells including the pixel electrodes PXL connected to the remaining data lines DL2 to DLm, and the liquid crystal cell connected to the first data line DL1 seems bright compared to the other liquid crystal cells. Moreover, since the pixel electrode PXL connected to the m^{th} data line DLm is connected to only the first parasitic capacitor Ca1 unlike the pixel electrodes PXL connected to both the first and second parasitic capacitors Ca1 and Ca2, the liquid crystal cell connected to the m^{th} data line DLm also seems relatively bright by generating the luminance difference with the other liquid crystal cells. This luminance difference is equally applied to the liquid crystal cells connected to the first and last gate lines.

As described above, since such a conventional LCD device generates a luminance difference between the outermost liquid crystal cells and the remaining liquid crystal cells, the outermost liquid crystal cells seem relatively bright. Particularly in an LCD panel of a middle or small sized LCD device, since a viewing distance is nearer than that of an LCD panel of a large sized LCD device, the outermost liquid crystal cells seem much brighter than the remaining liquid crystal cells.

### BRIEF SUMMARY OF THE INVENTION

The present invention provides an LCD panel, an LCD device, and a method thereof preventing a brightness phenomenon of outermost liquid crystal cells.

In order to achieve the above and other features and advantages of the invention, an LCD panel according to exemplary embodiments of the present invention includes TFTs connected to gate lines and to data lines, liquid crystal cells including pixel electrodes connected to the TFTs, and auxiliary capacitors connected to the liquid crystal cells, wherein the auxiliary capacitors connected to the liquid crystal cells corresponding to first and last signal lines of at least one of the gate lines and the data lines have different capacitances from auxiliary capacitors connected to the liquid crystal cells corresponding to remaining signal lines.

The auxiliary capacitors may be storage capacitors connected in parallel to the liquid crystal cells. Each storage capacitor may include a storage electrode, wherein an area of each storage electrode corresponding to the first and last signal lines may be greater than an area of each storage electrode corresponding to the remaining signal lines. The storage capacitor corresponding to each of the first and last signal lines may have greater capacitance than the storage capacitor corresponding to each of the remaining signal lines.

The LCD panel may further include parasitic capacitors formed between gate electrodes of the TFTs and the gate lines and drain electrodes of the TFTs. A width of the drain electrodes overlapping the gate electrodes of the first and last signal lines may be greater than a width of the drain electrodes overlapping the gate electrodes of the remaining signal lines. The parasitic capacitor connected to the storage capacitor corresponding to each of the first and last signal lines may have greater capacitance than the parasitic capacitor connected to the storage capacitor corresponding to each of the remaining signal lines.

The auxiliary capacitors may be parasitic capacitors formed between the data lines and the pixel electrodes. A distance between each of first and last data lines and each of the pixel electrodes connected to the first and last data lines may be shorter than a distance between each remaining data line and each of the pixel electrodes connected to the remaining data lines.

The auxiliary capacitors may be parasitic capacitors formed between the gate lines and the pixel electrodes. A distance between each of first and last gate lines and each of the pixel electrodes connected to the first and last gate lines is shorter than a distance between each remaining gate line and each of the pixel electrodes connected to the remaining gate lines.

All LCD device according to other exemplary embodiments of the present invention includes an LCD panel displaying an image, a gate driver supplying a scan signal to gate lines of the LCD panel, and a data driver supplying a data signal to data lines of the LCD panel whenever the scan signal is supplied, wherein the LCD panel includes TFTs connected to the gate lines and to the data lines, liquid crystal cells including pixel electrodes connected to the TFTs, and auxiliary capacitors connected to the liquid crystal cells, and wherein the auxiliary capacitors connected to the liquid crystal cells corresponding to first and last signal lines of at least one of the gate lines and the data lines have different capacitances from auxiliary capacitors connected to the liquid crystal cells corresponding to remaining signal lines.

A method of preventing a brightness phenomenon in outermost liquid crystal cells on an LCD panel according to other exemplary embodiments of the present invention includes providing auxiliary capacitors connected to liquid crystal cells corresponding to first and last gate lines and first and last data lines with a different capacitance from auxiliary capacitors connected to liquid crystal cells corresponding to remaining gate and data lines in the LCD panel.

### BRIEF DESCRIPTION OF THE DRAWINGS

The above and other features and advantages of the present invention will become more apparent from the following detailed description when taken in conjunction with the accompanying drawings in which:

FIG. 1 is a diagram illustrating parasitic capacitors between data lines and pixel electrodes of a conventional LCD panel;

FIG. 2 is a block diagram of an exemplary LCD device according to a first exemplary embodiment of the present invention;

FIGS. 3A and 3B are plan views illustrating exemplary pixel electrodes and exemplary storage electrodes constituting the exemplary storage capacitors shown in FIG. 2;

FIG. 4 is a block diagram of an exemplary LCD device according to a second exemplary embodiment of the present invention;

FIGS. 5A and 5B are plan views illustrating exemplary data lines and exemplary pixel electrodes constituting the first to third exemplary parasitic capacitors shown in FIG. 4;

FIG. 6 is a circuit diagram of an exemplary LCD panel according to a third exemplary embodiment of the present invention;

FIGS. 7A and 7B are plan views illustrating exemplary gate lines and exemplary pixel electrodes constituting the exemplary first to third parasitic capacitors shown in FIG. 6; and

FIG. 8 is a circuit diagram of an exemplary LCD panel according to a fourth exemplary embodiment of the present invention.

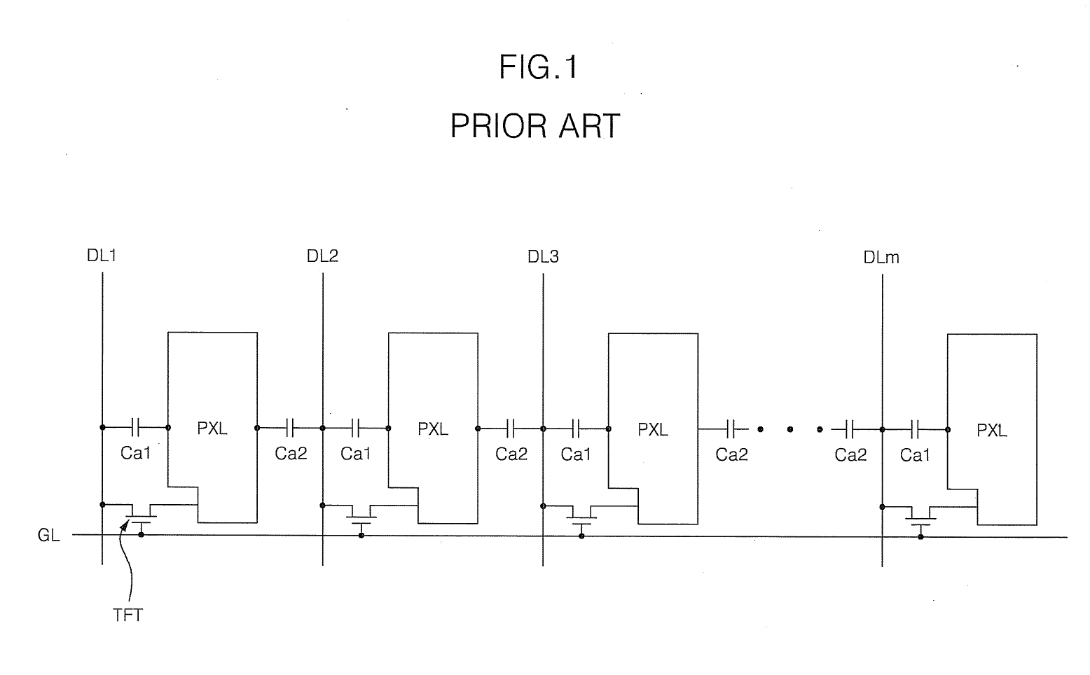

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

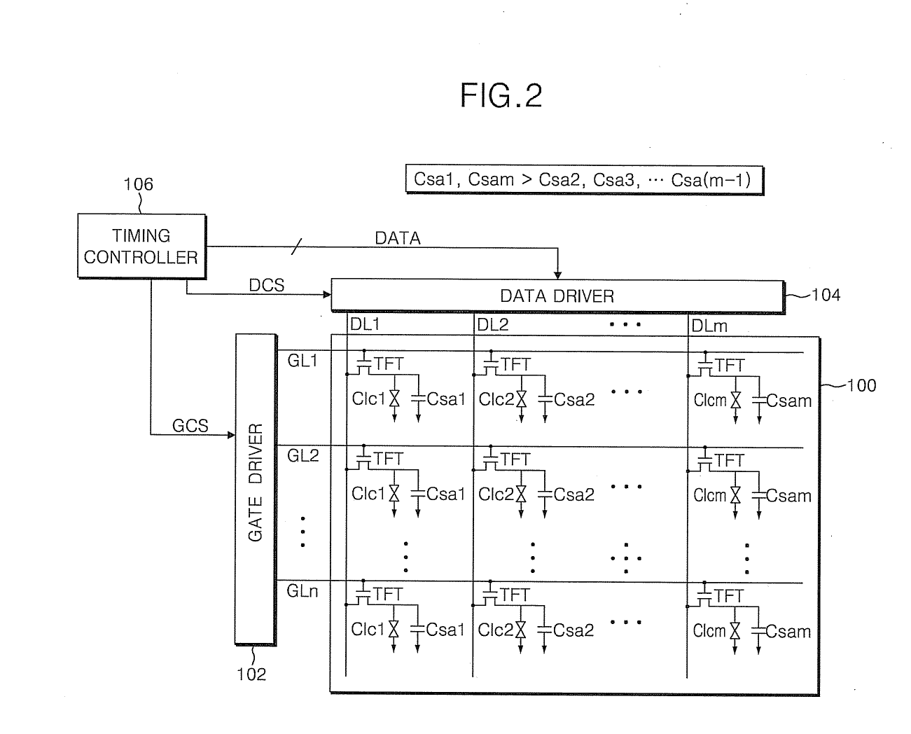

Exemplary embodiments of the present invention will now be described with reference to FIGS. 2 to 8.

FIG. 2 is a block diagram of an exemplary LCD device according to a first exemplary embodiment of the present invention.

Referring to FIG. 2, the LCD device includes an LCD panel 100 for displaying an image, gate and data drivers 102 and 104 for driving the LCD panel 100, and a timing controller 106 for controlling the gate and data drivers 102 and 104.

The timing controller 106 arranges a data signal input from the exterior and supplies the data signal to the data driver 104. The timing controller 106 generates a plurality of control signals for controlling driving timings of the gate and data drivers 102 and 104, by using a plurality of synchronization signals input from the exterior together with the data signal, for example, by using a dot clock, a data enable signal, a vertical synchronization signal and a horizontal synchronization signal. Specifically, the timing controller 106 generates gate control signals GCS including a gate start pulse and a gate shift clock and supplies the gate control signals GCS to the gate driver 102. Furthermore, the timing controller 106 generates data control signals DCS including a data start pulse, a data shift clock, and a polarity control signal and supplies the data control signals DCS to the data driver 104.

The gate driver 102 sequentially drives gate lines GL1 to GLn formed on the LCD panel 100. To this end, the gate driver 102 generates a scan signal while sequentially shifting through an internal shift register the gate start pulse supplied from the timing controller 106 by using the gate shift clock.

The data driver 104 converts digital data into analog data signals in response to the data control signals DCS supplied from the timing controller 106 and supplies the analog data signals to data lines DL1 to DLm formed on the LCD panel 100 whenever a turn-on voltage of the scan signal is supplied to the gate lines GL1 to GLn of the LCD panel 100.

The gate lines GL1 to GLn extend in a first direction from the gate driver 102, and the data lines DL1 to DLm extend in a second direction from the data driver 104, where the second direction is substantially perpendicular to the first direction. The data lines DL1 to DLm are insulated from the gate lines GL1 to GLn and intersect the gate lines GL1 to GLn. TFTs are formed in regions provided by intersections of the gate and data lines GL1 to GLn and DL1 to DLm, liquid crystal cells Clc1 to Clem are connected to the TFTs, and storage capacitors Csa1 to Csam are connected in parallel to the liquid crystal cells Clc1 to Clcm.

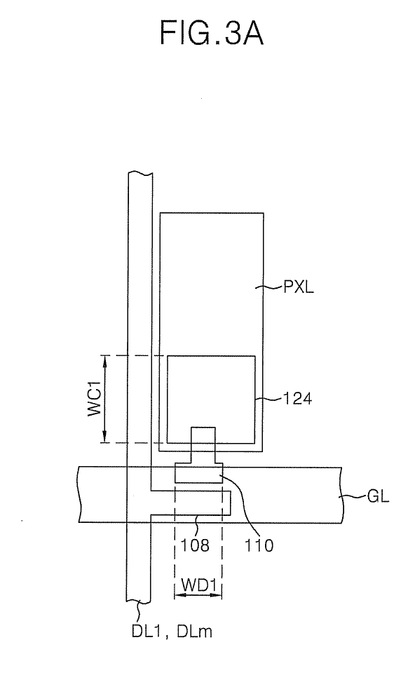

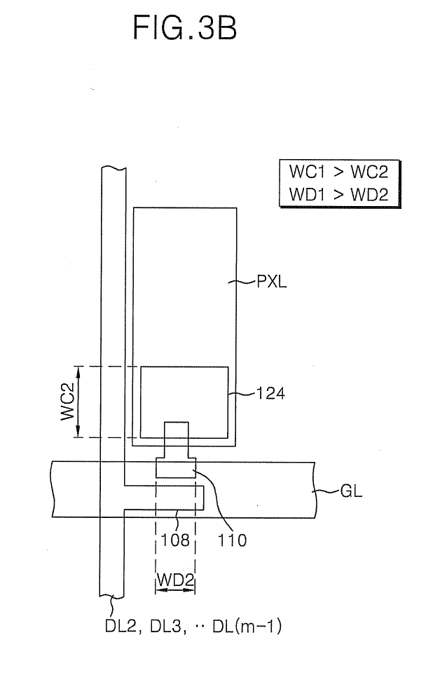

Each TFT includes a gate electrode connected to one of the gate lines, a source electrode 108 connected to one of the data lines, a drain electrode 110 connected to a pixel electrode PXL, and a semiconductor layer (not shown) for forming a channel between the source electrode 108 and the drain electrode 110, where source electrode 108 and drain electrode 110 are shown in FIGS. 3A and 3B. Storage electrodes 124 are formed of the same metal and within the same layer as the gate lines GL1 to GLn. The storage electrodes 124, as well as the gate metal pattern, may be overlapped by a gate insulating layer (not shown). The semiconductor layer may be formed on the gate insulating layer at least in a location over the gate electrodes. A data metal pattern, including the data lines DL1 to DLm, source electrodes 108, and drain electrodes 110, may then be formed on the gate insulating layer, with the source electrodes 108 and drain electrodes 110 spaced over the semiconductor layer over the gate electrodes, thus forming the channel for each TFT there between. A passivation layer (not shown) may be formed over the resultant structure, and the pixel electrodes PXL may be formed on the passivation layer. Contact holes penetrating the passivation layer may allow for the connection of the pixel electrodes PXL to the drain electrodes 110.

The storage capacitors Csa1 to Csam have different capacitances depending on their locations with respect to the data lines DL1 to DLm. Specifically, the capacitance of each of the second to (m−1)^{th} storage capacitors Csa2 to Csa(m⁻¹) corresponding to the second to (m−1)^{th} data lines DL2 to DL(m−1) is less than the capacitance of each of the first and m^{th} storage capacitors Csa1 and Csam corresponding to the first and m^{th} data lines DL1 and DLm.

To this end, as shown in FIG. 3A, each of the first and m^{th} storage capacitors Csa1 and Csam includes the pixel electrode PXL and the storage electrode 124 having a first width WC1. As shown in FIG. 3B, each of the second to (m−1)^{th} storage capacitors Csa2 to Csa(m−1) includes the pixel electrode PXL and the storage electrode 124 having a second width WC2 narrower than the first width WC1. In other words, a cross-sectional area of each of the first and m^{th} storage electrodes 124 is greater than a cross-sectional area of each of the second to (m−1)^{th} storage electrodes 124.

Since the capacitance of each of the first and m^{th} storage capacitors Csa1 and Csam is greater than that of each of the second to (m−1)^{th} storage capacitors Csa2 to Csa(m−1) as described above, loads of the TFTs connected to the first and m^{th} storage capacitors Csa1 and Csam are increased. As a result, the current driving capability of each of the TFTs connected to the first and m^{th} storage capacitors Csa1 and Csam becomes lower than that of each of the TFTs connected to the second to (m−1)^{th} storage capacitors Csa2 to Csa(m⁻¹). Therefore, a charge rate of a pixel voltage signal supplied to the pixel electrode PXL through each of the TFTs that are connected to the first and m^{th} storage capacitors Csa1 and Csam and have low current driving capability is lower than a charge rate of a pixel voltage signal supplied to the pixel electrode PXL through each of the TFTs connected to the other storage capacitors Csa2 to Csa(m−1). Thus, a luminance difference between liquid crystal cells corresponding to the first and m^{th} data lines DL1 and DLm and those corresponding to the other remaining data lines DL2 to DL(m⁻¹) can be prevented by lowering the charge rate of liquid crystal cells corresponding to the first and m^{th} data lines DL1 and DLm.

Meanwhile, if the capacitance of each of the first and m^{th} storage capacitors Csa1 and Csam is greater than that of each of the other storage capacitors Csa2 to Csa(m−1), a kickback voltage Vkb that is in inverse proportion to the capacitance of the storage capacitor Csa varies according to the position of the liquid crystal cell Clc as represented by the following equation:

$$Vkb = \frac{Cgd}{Clc + Csa + Cgd}$$

where Vkb represents the kickback voltage, Cgd represents capacitance of the parasitic capacitor Cgd between the gate line and the drain electrode 110, Clc represents the capacitance of the liquid crystal cell, and Csa represents the capacitance of the storage capacitor. In order to maintain the kickback voltage Vkb the same with respect to all the liquid crystal cells Clc, the capacitance of the parasitic capacitor Cgd between the gate line and the drain electrode 110 is adjusted.

That is, the parasitic capacitor Cgd between the gate electrode corresponding to each of the first and m^{th} storage capacitors Csa1 and Csam and the drain electrode 110 is adjusted to be greater than the parasitic capacitor Cgd between the gate electrode corresponding to each of the other storage capacitors Csa2 to Csa(m−1) and the drain electrode 110.

To this end, as shown in FIG. 3A, the drain electrode 110, that is connected to each of the first and m^{th} storage capacitors Csa1 and Csam and overlaps the gate line GL, where a portion of the gate line GL forms the gate electrode, to form the parasitic capacitor Cgd, has a width WD1. As shown in FIG. 3B, the drain electrode 110, that is connected to each of the second to (m−1)^{th} storage capacitors Csa2 to Csa(m−1) and overlaps the gate line GL to form the parasitic capacitor Cgd, has a width WD2. The width WD1 is set to be wider than the width WD2.

As described above, the difference of the kickback voltages Vkb, caused by the difference of the capacitances of the storage capacitors Csa1 to Csam, can be compensated for by adjusting the capacitance of the parasitic capacitor that has an influence on the kickback voltage Vkb.

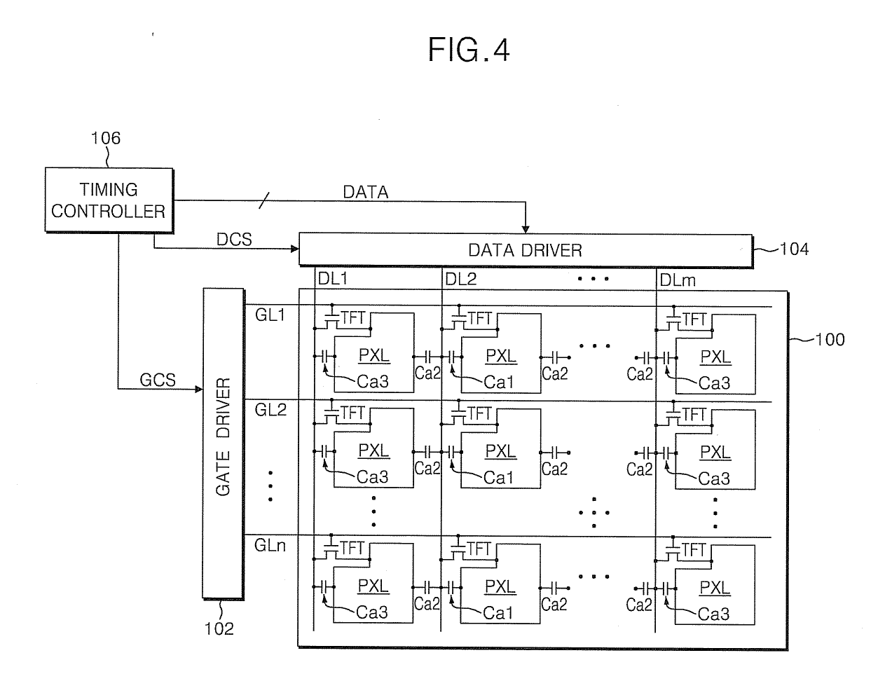

FIG. 4 is a block diagram of an exemplary LCD device according to a second exemplary embodiment of the present invention.

The LCD device of FIG. 4 has substantially the same construction as that of FIG. 2 except that capacitances of parasitic capacitors between data lines and pixel electrodes vary. Therefore, a detailed description of the same constituent elements will be omitted.

The gate lines GL1 to GLn and the data lines DL1 to DLm are formed on a first substrate of the LCD panel 100. The data lines DL1 to DLm are insulated from the gate lines GL1 to GLn and intersect the gate line GL1 to GLn. TFTs are formed in regions provided by intersections of the gate and data lines GL1 to GLn and DL1 to DLm, and pixel electrodes PXL are connected to the TFTs and provide liquid crystal cells by forming an electric field together with a common electrode formed on a second substrate of the LCD panel 100, with liquid crystal disposed between the first and second substrates.

Each of the second to (m−1)^{th} data lines DL2 to DLm−1 forms first and second parasitic capacitors Ca1 and Ca2 together with the pixel electrodes PXL on the right and left sides thereof respectively. Each of the first and m^{th} data lines DL1 and DLm forms a third parasitic capacitor Ca3 together with the pixel electrode PXL on the left or right side thereof. Here, the third parasitic capacitor Ca3 has a capacitance value of the sum of capacitances of the first and second parasitic capacitors Ca1 and Ca2.

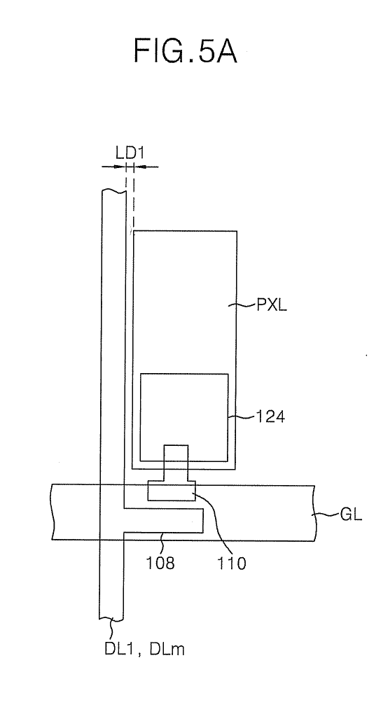

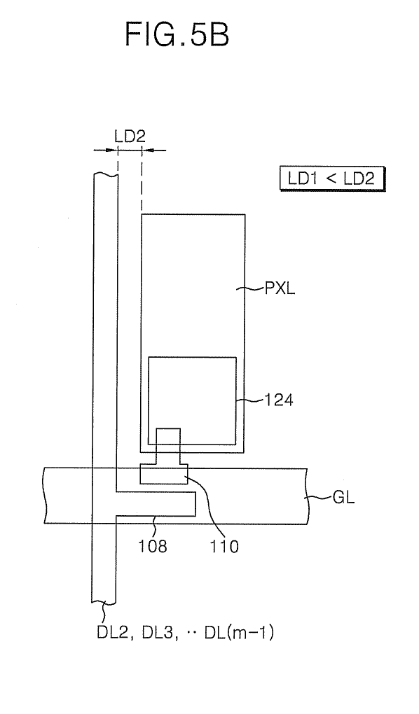

This is possible by adjusting a distance between the data lines DL1 to DLm and the pixel electrodes PXL, which is in inverse proportion to the capacitance of the parasitic capacitor. As shown in FIG. 5A, each of the first and m^{th} data lines DL1 and DLm and the pixel electrode PXL are separated from each other with a first distance LD1 there between. As shown in FIG. 5B, each of the other remaining data lines DL2 to DLm−1 and the pixel electrode PXL are separated from each other with a second distance LD2, where the second distance LD2 is longer than the first distance LD1.

Hence, a variation of a pixel voltage signal charged to each of the pixel electrodes PXL connected to the second to (m−1)^{th} data lines DL2 to DLm−1 due to a coupling phenomenon of the first and second parasitic capacitors Ca1 and Ca2 is similar to that charged to each of the pixel electrodes PXL connected to the first and m^{th} data lines DL1 to DLm due to the third parasitic capacitor Ca3. Since the variations of the pixel voltage signals charged to the pixel electrodes PXL become similar to each other, a brightness phenomenon of a specific liquid crystal cell can be prevented.

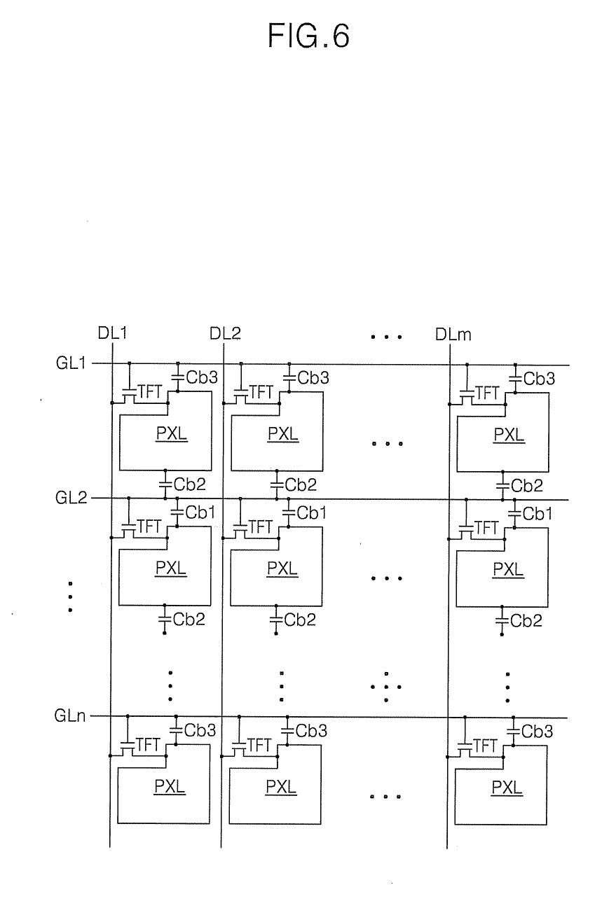

FIG. 6 illustrates an exemplary LCD panel according to a third exemplary embodiment of the present invention.

The LCD panel of FIG. 6 has substantially the same construction as that of FIG. 2 except that capacitances of parasitic capacitors between gate lines and pixel electrodes vary. Therefore, a detailed description of the same constituent elements will be omitted.

Referring to FIG. 6, the LCD panel includes a first substrate having gate lines GL1 to GLn, data lines DL1 to DLm insulated from the gate lines GL1 to GLn and intersecting the gate lines GL1 to GLn, TFTs formed in regions provided by intersections of the gate and data lines GL1 to GLn and DL1 to DLm, and pixel electrodes PXL connected to the TFTs and providing liquid crystal cells by forming an electric field together with a common electrode formed on a second substrate of the LCD panel, with liquid crystal disposed between the first and second substrates.

Each of the second to (n−1)^{th} gate lines GL2 to GLn−1 forms first and second parasitic capacitors Cb1 and Cb2 together with the pixel electrodes PXL on the lower and upper sides thereof, respectively. Each of the first and n^{th} gate lines GL1 and GLn forms a third parasitic capacitor Cb3 together with the pixel electrode PXL on the lower side thereof. Here, the third parasitic capacitor Cb3 has a capacitance value of the sum of capacitances of the first and second parasitic capacitors Cb1 and Cb2. This is possible by adjusting a distance between the gate lines GL1 to GLn and the pixel electrodes PXL, which is in inverse proportion to the capacitance of the parasitic capacitor.

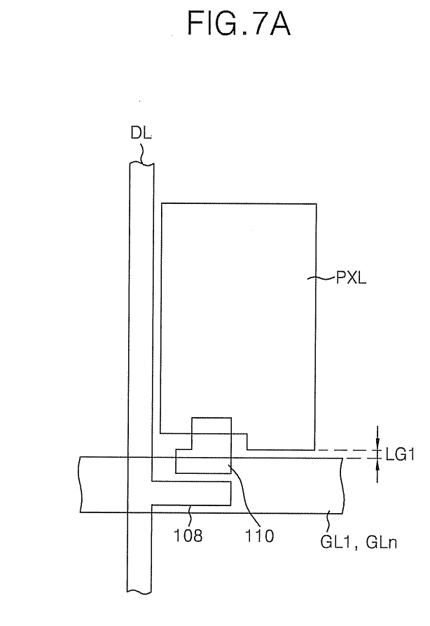

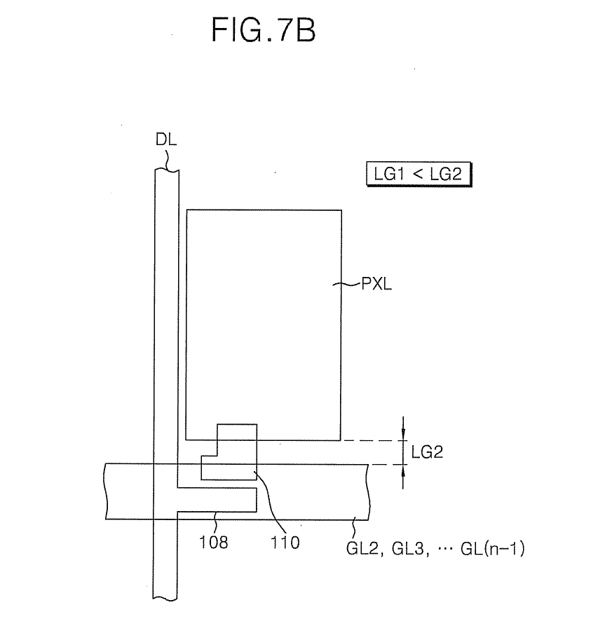

Specifically, as shown in FIG. 7A, each of the first and n^{th} gate lines GL1 and GLn and the pixel electrode PXL are separated from each other with a first distance LG1 there between. As shown in FIG. 7B, each of the other remaining gate lines GL2 to GLn−1 and the pixel electrode PXL are separated from each other with a second distance LG2, where the second distance LG2 is longer than the first distance LG1. The first distance LG1 may be made smaller than the second distance LG2 by extending a portion of the pixel electrode PXL closer to the first and nth gate lines GL1 and GLn.

Hence, a variation of a pixel voltage signal charged to each of the pixel electrodes PXL connected to the second to (n−1)^{th} gate lines GL2 to GLn−1 due to a coupling phenomenon of the first and second parasitic capacitors Cb1 and Cb2 is similar to that charged to each of the pixel electrodes PXL connected to the first and n^{th} gate lines GL1 to GLn due to the third parasitic capacitor Cb3. Since the variations of the pixel voltage signals charged to the pixel electrodes PXL become similar to each other, a brightness phenomenon of a specific liquid crystal cell can be prevented.

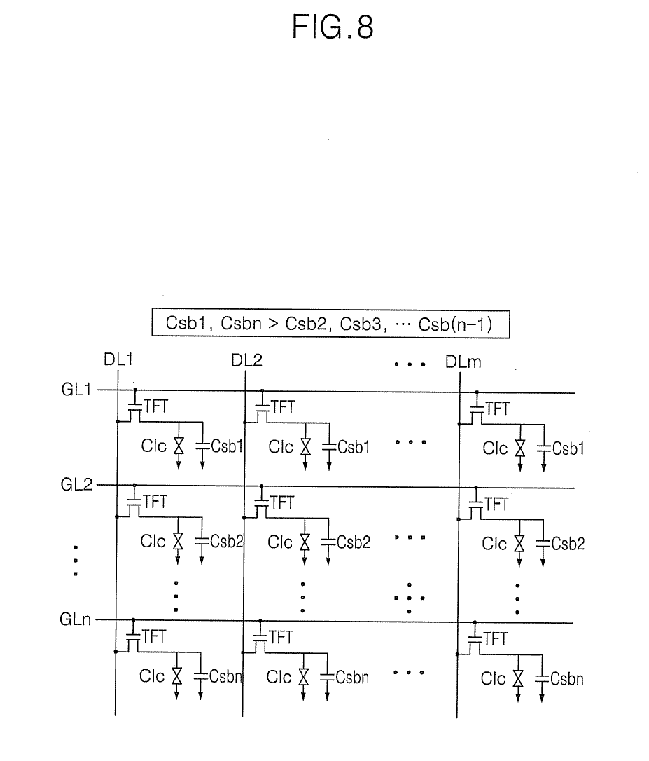

FIG. 8 illustrates an exemplary LCD panel according to a fourth exemplary embodiment of the present invention.

The LCD panel of FIG. 8 has substantially the same construction as that of FIG. 2 except that capacitances of storage capacitors vary according to the location of a gate line. Therefore, a detailed description of the same constituent elements will be omitted.

Storage capacitors Csb1 to Csbn have different capacitances according to the locations of the gate lines GL1 to GLn. Specifically, the capacitance of each of the first and n^{th} storage capacitors Csb1 and Csbn corresponding to the first and n^{th} gate lines GL1 and GLn is set to be greater than the capacitance of each of the second to (n−1)^{th} storage capacitors Csb2 to Csb(n−1) corresponding to the second to (n−1)^{th} gate lines GL2 to GL(n−1). To this end, the area of the storage electrode that is in proportion to the capacitance of the storage capacitor, and a distance between the pixel electrode and the storage electrode, which is in inverse proportion to the capacitance of the storage capacitor are adjusted.

Since the capacitance of each of the first and n^{th} storage capacitors Csb1 and Csbn is adjusted to be greater than the capacitance of each of the second to (n−1)^{th} storage capacitors Csb2 to Csb(n−1) as described above, loads of TFTs connected to the first and n^{th} storage capacitors Csb1 and Csbn are increased. Then a charge rate of a pixel voltage signal supplied to the pixel electrode PXL through each of the TFTs that are connected to the first and n^{th} storage capacitors Csb1 and Csbn is lower than a charge rate of a pixel voltage signal supplied to the pixel electrode PXL through each of the TFTs that are connected to the other storage capacitors Csb2 to Csb(n−1). Thus, a luminance difference between liquid crystal cells corresponding to the first and n^{th} gate lines GL1 and GLn and those corresponding to the other remaining gate lines GL2 to GL(n−1) can be prevented by lowering the charge rate of the liquid crystal cells corresponding to the first and n gate lines GL1 and GLn.

Meanwhile, the difference of the kickback voltages Vkb generated as the capacitances of the first and n^{th} storage capacitors Csb1 and Csbn are increased compared to the capacitances of the other storage capacitors Csb2 to Csb(n−1) is compensated for by controlling the capacitance of the parasitic capacitor Cgd between the gate line and the drain electrode.

For example, the parasitic capacitor Cgd between the gate electrode and the drain electrode corresponding to each of the first and n^{th} storage capacitors Csb1 and Csbn is set to be greater than that between the gate electrode and the drain electrode corresponding to each of the other storage capacitors Csb2 to Csb(n−1).

Meanwhile, in the exemplary LCD panel according to exemplary embodiments of the present invention, the capacitances of the storage capacitors connected to the first and last gate lines and to the first and last data lines may be formed to be greater than those of the other storage capacitors.

Furthermore, in the exemplary LCD panel according to the exemplary embodiments of the present invention, the capacitances of the parasitic capacitors (namely, the parasitic capacitors between the data lines and the pixel electrodes, or between the gate lines and the pixel electrodes) connected to the first and last gate lines and to the first and last data lines may be formed to be greater than those of the other parasitic capacitors.

In other words, the above-described embodiments may be combined in various combinations within the same exemplary LCD panels, such that a brightness phenomenon is prevented in outermost liquid crystal cells connected to first and last gate lines as well as to first and last data lines.

A method of preventing a brightness phenomenon in outermost liquid crystal cells of a liquid crystal display panel may thus include providing auxiliary capacitors connected to liquid crystal cells corresponding to first and last gate lines and first and last data lines with a different capacitance from auxiliary capacitors connected to liquid crystal cells corresponding to remaining gate and data lines in the liquid crystal display panel.

As is apparent from the foregoing description, the LCD panel, the LCD device, and the method thereof according to exemplary embodiments of the present invention form the capacitances of the storage capacitors or parasitic capacitors connected to the outermost liquid crystal cells to be different from those of the storage capacitors or parasitic capacitors connected to the other liquid crystal cells. Therefore, a brightness phenomenon of the outermost liquid crystal cells can be prevented without changing a black matrix and an aperture ratio.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A liquid crystal display panel, comprising:
thin film transistors connected to gate lines and to data lines;
liquid crystal cells including pixel electrodes connected to the thin film transistors; and
auxiliary capacitors connected to the liquid crystal cells;
wherein the auxiliary capacitors connected to the liquid crystal cells corresponding to first and last signal lines of at least one of the gate lines and the data lines have different capacitances from auxiliary capacitors connected to the liquid crystal cells corresponding to remaining signal lines.

2. The liquid crystal display panel according to claim 1, wherein the auxiliary capacitors are storage capacitors connected in parallel to the liquid crystal cells.

3. The liquid crystal display panel according to claim 2, wherein each storage capacitor includes a storage electrode, and wherein an area of each storage electrode corresponding to the first and last signal lines is greater than an area of each storage electrode corresponding to the remaining signal lines.

4. The liquid crystal display panel according to claim 2, wherein the storage capacitor corresponding to each of the first and last signal lines has greater capacitance than the storage capacitor corresponding to each of the remaining signal lines.

5. The liquid crystal display panel according to claim 4, further comprising parasitic capacitors formed between drain electrodes of the thin film transistors and gate electrodes of the thin film transistors and the gate lines.

6. The liquid crystal display panel according to claim 5, wherein a width of the drain electrodes overlapping the gate electrodes of the first and last signal lines is greater than a width of the drain electrodes overlapping the gate electrodes of the remaining signal lines.

7. The liquid crystal display panel according to claim 5, wherein the parasitic capacitor connected to the storage capacitor corresponding to each of the first and last signal lines has greater capacitance than the parasitic capacitor connected to the storage capacitor corresponding to each of the remaining signal lines.

8. The liquid crystal display panel according to claim 1, wherein the auxiliary capacitors are parasitic capacitors formed between the data lines and the pixel electrodes.

9. The liquid crystal display panel according to claim 8, wherein a distance between each of first and last data lines and each of the pixel electrodes connected to the first and last data lines is shorter than a distance between each remaining data line and each of the pixel electrodes connected to the remaining data lines.

10. The liquid crystal display panel according to claim 1, wherein the auxiliary capacitors are parasitic capacitors formed between the gate lines and the pixel electrodes.

11. The liquid crystal display panel according to claim 10, wherein a distance between each of first and last gate lines and each of the pixel electrodes connected to the first and last gate lines is shorter than a distance between each remaining gate line and each of the pixel electrodes connected to the remaining gate lines.

12. A liquid crystal display device, comprising:
a liquid crystal display panel displaying an image;
a gate driver supplying a scan signal to gate lines of the liquid crystal display panel; and
a data driver supplying a data signal to data lines of the liquid crystal display panel whenever the scan signal is supplied,
the liquid crystal display panel including thin film transistors connected to the gate lines and to the data lines, liquid crystal cells including pixel electrodes connected to the thin film transistors, and auxiliary capacitors connected to the liquid crystal cells, wherein the auxiliary capacitors connected to the liquid crystal cells corresponding to first and last signal lines of at least one of the gate lines and the data lines have different capacitances from auxiliary capacitors connected to the liquid crystal cells corresponding to remaining signal lines.

13. The liquid crystal display device according to claim 12, wherein the auxiliary capacitors are storage capacitors connected in parallel to the liquid crystal cells.

14. The liquid crystal display device according to claim 13, wherein the storage capacitor corresponding to each of the first and last signal lines has greater capacitance than the storage capacitor corresponding to each of the remaining signal lines.

15. The liquid crystal display device according to claim 14, further comprising parasitic capacitors formed between drain electrodes of the thin film transistors and gate electrodes of the thin film transistors and the gate lines.

16. The liquid crystal display device according to claim 15, wherein the parasitic capacitor connected to the storage capacitor corresponding to each of the first and last signal lines has greater capacitance than the parasitic capacitor connected to the storage capacitor corresponding to each of the remaining signal lines.

17. The liquid crystal display device according to claim 12, wherein the auxiliary capacitors are parasitic capacitors formed between the data lines and the pixel electrodes.

18. The liquid crystal display device according to claim 17, wherein a distance between each of first and last data lines and each of the pixel electrodes connected to the first and last data lines is shorter than a distance between each remaining data line and each of the pixel electrodes connected to the remaining data lines.

19. The liquid crystal display device according to claim 12, wherein the auxiliary capacitors are parasitic capacitors formed between the gate lines and the pixel electrodes.

20. The liquid crystal display device according to claim 19, wherein a distance between each of first and last gate lines and each of the pixel electrodes connected to the first and last gate lines is shorter than a distance between each remaining gate line and each of the pixel electrodes connected to the remaining gate lines.

21. A method of preventing a brightness phenomenon in outermost liquid crystal cells of a liquid crystal display panel, the liquid crystal display panel having thin film transistors connected to gate lines and to data lines, and liquid crystal cells including pixel electrodes connected to the thin film transistors, the method comprising:
providing auxiliary capacitors connected to liquid crystal cells corresponding to first and last gate lines and first and last data lines with a different capacitance from auxiliary capacitors connected to liquid crystal cells corresponding to remaining gate and data lines in the liquid crystal display panel.
